(19) United States
(12) Patent Application Publication
(10) Pub. No.: US 2024/0424939 A1
(43) Pub. Date: Dec. 26, 2024

(54) Electric Vehicle Charging Optimization Through Charging Perturbation Across On-Road EV Fleets

(71) Applicant: Robert Bosch GmbH, Stuttgart (DE)

(72) Inventors: Nikhil Ravi, Redwood City, CA (US); Reinhardt Klein, Mountain View, CA (US); Maksim Subbotin, San Carlos, CA (US); Camille Usubelli, San Jose, CA (US); Ravin Singh, Sunnyvale, CA (US)

(21) Appl. No.: 18/338,427

(22) Filed: Jun. 21, 2023

(51) Int. Cl. B60L 53/66; B60L 53/30; B60L 53/62; H02J 7/00

(52) U.S. Cl. CPC B60L 53/66; B60L 53/305; B60L 53/62; H02J 7/007194

(57) ABSTRACT

Systems and methods are disclosed for optimizing charging protocols across the fleet of electric vehicles over time. In particular, a cloud backend generates one or more alternative or experimental charging protocols by perturbing a baseline charging profile of a baseline charging protocol. The ‘perturbed’ charging protocol(s) are deployed to a subset of the fleet of electric vehicles. As the subset of the fleet of electric vehicles charge their batteries using the perturbed charging protocol(s), the cloud backend observes, based on battery data received from the subset of the fleet of electric vehicles, an impact of the perturbed charging protocol(s) on battery aging and charging times. Based on these battery data, the cloud backend revises and improves the baseline charging protocol that is deployed to the entire fleet of electric vehicles.

### FIELD

The device and method disclosed in this document relates to battery charging and, more particularly, to optimizing electric vehicle charging across a fleet of electric vehicles.

### BACKGROUND

Unless otherwise indicated herein, the materials described in this section are not admitted to be the prior art by inclusion in this section.

The particular charging protocol(s) used to charge a battery of an electric vehicle can have a significant impact on the long-term degradation of the battery. This is particularly the case when electric vehicles are charged at high power with DC fast chargers. The charging current used to the charge the battery in an electric vehicle is typically governed by a Battery Management System (BMS) on board the electric vehicle, which implements the charging protocol(s). Typically, the charging protocol(s) deployed on the BMS are designed by a battery manufacturer prior to release of the vehicle. The charging protocol typically takes the form of a static map of charge current as a function of battery temperature and battery voltage. The charging protocol(s) are generally designed to maximize a charging speed without having a significant impact on battery degradation.

However, because these charging protocol(s) are derived experimentally under lab conditions, they are not necessarily optimized for real-world operation across a wide variety of operating conditions. As a result, these charging protocol(s) may be too conservative (providing slower charging than necessary) under certain conditions and may be too aggressive (leading to faster than expected battery aging) under certain conditions. Further, batteries degrade during usage, and the static BMS charge maps, even if optimal at beginning of life, might no longer be optimal in terms of charge time and/or aging. Therefore, it would be advantageous to have a methodology to adapt the baseline charge profile derived under lab settings based on the real-world battery performance and aging observed on the road.

### SUMMARY

A method for adapting a charging protocol for charging batteries of a plurality of electric vehicles. The method comprises storing, in a memory of a server, a baseline charging protocol. The method further comprises determining, with a processor of the server, a plurality of alternative charging protocols by modifying the baseline charging protocol. The method further comprises transmitting, with a transceiver of the server, to each respective electric vehicle from a subset of the plurality of electric vehicles, a respective alternative charging protocol from the plurality of alternative charging protocols, the subset of the plurality of electric vehicles being configured to charge batteries thereof according to the plurality of alternative charging protocols. The method further comprises receiving, with the transceiver, battery data from the subset of the plurality of electric vehicles, the battery data having been measured during or after charging the batteries of the subset of the plurality of electric vehicles according to the plurality of alternative charging protocols. The method further comprises updating, with the processor, the baseline charging protocol based on the battery data.

A method for adapting a charging protocol for charging a battery of an electric vehicle is disclosed. The method comprises receiving, with a transceiver of a battery management system, an alternative charging protocol from a server. The method further comprises controlling, with a processor of the battery management system, a charging of the battery according to the alternative charging protocol. The method further comprises measuring, with at least one sensor of the battery management system, battery data during or after the charging of the battery according to the alternative charging protocol. The method further comprises transmitting, with the transceiver, the battery data to the server. The method further comprises receiving, with the transceiver, an updated baseline charging protocol, the updated baseline charging protocol having been determined based on the battery data and further battery data from further electric vehicles.

### BRIEF DESCRIPTION OF THE DRAWINGS

The foregoing aspects and other features of the methods are explained in the following description, taken in connection with the accompanying drawings.

FIG. 1 shows an exemplary embodiment of a system for optimizing battery charging protocols across a fleet of electric vehicles.

FIG. 2 shows an exemplary battery charging system of an electric vehicle.

FIG. 3 shows exemplary components of the cloud backend.

FIG. 4 shows a method for optimizing battery charging protocols across a fleet of electric vehicles.

FIG. 5 shows exemplary baseline and perturbed current-voltage profiles for a particular battery temperature.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### System Overview

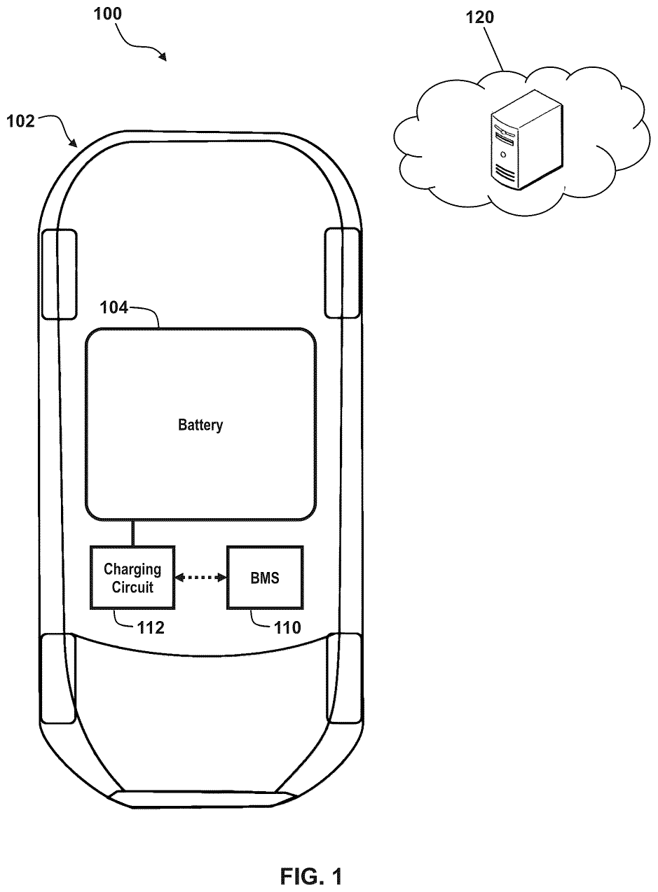

FIG. 1 shows an exemplary embodiment of a system 100 for optimizing battery charging protocols across a fleet of electric vehicles. The system 100 comprises a plurality of electric vehicles 102 (only one is illustrated for simplicity) and a cloud backend 120. As will be discussed in greater detail below, the cloud backend 120 advantageously operates to continuously adapt and improve upon the charging protocol(s) leveraged by the electric vehicles 102 in the fleet.

Each electric vehicle 102 in the fleet includes at least one battery 104, which is rechargeable and configured to provide power to a drive system (not shown) of the electric vehicle 102. In at least some embodiments, the battery 102 is a lithium-ion battery pack consisting of multiple individual cells connected in series and parallel to achieve the desired voltage and capacity. The battery 102 may, for example, be located under the floor or seats of the electric vehicle.

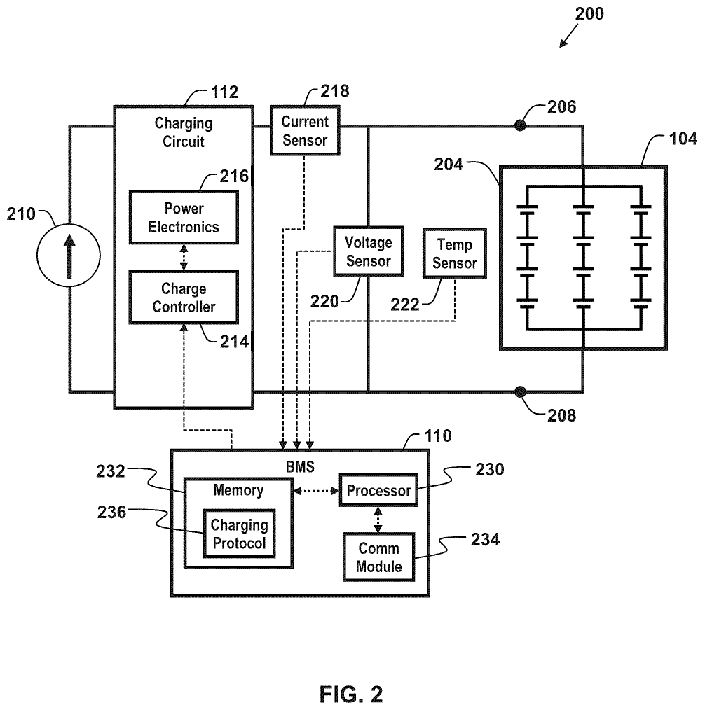

Additionally, each electric vehicle 102 further includes a battery management system (BMS) 110 configured to monitor individual cell performance, temperature, and overall health of the battery 104. Moreover, the BMS 110 is configured to implement a charging protocol to optimize charging (and discharging) processes of the battery 102 to minimize charging times of the battery 102, to maximize that lifespan of the battery 102, and to ensure that the battery 102 operates within safe limits. To these ends, the BMS 110 is configured to receive sensor data from one or more sensors (shown in FIG. 2) and operate a charging circuit 112 to charge the battery 102 according to a given charging protocol.

The cloud backend 120 is configured to optimize charging protocols across the fleet of electric vehicles 102 over time. In particular, the cloud backend 120 is configured to generate one or more alternative or experimental charging protocols by perturbing a baseline charging profile of a baseline charging protocol and deploying the ‘perturbed’ charging protocol to a subset of the fleet of electric vehicles 102. As the subset of the fleet of electric vehicles 102 charge their batteries 104 using the perturbed charging protocol, the cloud backend 120 observes, by way of battery data received from the subset of the fleet of electric vehicles 102, an impact of the perturbed charging protocol(s) on battery aging and charging times. Based on these battery data, the cloud backend 120 revises and improves the baseline charging protocol that is deployed to the entire fleet of electric vehicles 102.

### Exemplary Hardware Embodiments

FIG. 2 shows an exemplary battery charging system 200 of the electric vehicle 102. The system 200 includes the battery 104, the BMS 110, and the charging circuit 112 mentioned above with respect to FIG. 1. It will be appreciated that the components of the battery charging system 200 described herein are merely exemplary and that the battery charging system 200 may comprise any alternative configuration.

The battery 104 is configured to store electrochemical energy. The battery 104 includes one or more electrochemical cells 204 arranged in parallel and/or in series to form the battery 104. In one embodiment, the battery 104 is a lithium-ion battery pack and the electrochemical cells 204 are lithium-ion cells. The battery 104 includes a positive battery terminal 206 and a negative battery terminal 208 via which the battery 104 provides an output voltage and an output current. Additionally, the battery 104 is configured to be charged via the positive and negative battery terminals 206, 208.

The system 200 further includes a power source 210 and a charging circuit 112. The power source 210 is configured to, during a charging process, apply a charging current and/or a charging voltage to battery 104 via the positive and negative battery terminals 206, 208. In some embodiment, the power source 210 is configured to provide predetermined constant direct-current (DC) voltage or current. In some embodiments, the power source 210 is an alternating-current (AC) voltage or current source. In one embodiment, the power source 210 is a local electric grid (mains) configured to provide a single-phase or three-phase AC voltage having a predetermined frequency, such as 50 Hz or 60 Hz, and a predetermined nominal voltage, such as a nominal voltage between 110-127 volts or 220-240 volts.

The charging circuit 112 is connected between the power source 210 and the battery 104 and is configured to convert, regulate, and/or control the charging current and/or the charging voltage applied to the battery 104 by the power source 210. In some embodiments, the charging circuit 112 includes a charge controller 214 that operates various power electronics 216 to convert, regulate, and/or control the charging current and/or the charging voltage applied to the battery 104. The power electronics 216 includes various circuits and hardware that may include, for example, contactors, relays, transistors, transformers, diodes, capacitors, inductors, and resistors arranged in a conventional manner. In some embodiments, additional power conversion circuits may be arranged between the power source 210 and the charging circuit 112, such as a separate AC/DC converter.

The charge controller 214 may be a component of the BMS 110 or be a discrete component that receives commands from the BMS 110 for the purpose of controlling the charging process of the battery 104 in accordance with a particular charging protocol. It will be recognized by those of ordinary skill in the art that a “controller” includes any hardware system, hardware mechanism or hardware component that processes data, signals, or other information. Thus, the charge controller 214 may include a system with a central processing unit, multiple processing units, dedicated circuitry for achieving specific functionality, or other systems.

The BMS 110 comprises a processor 230 configured to execute program instructions which are stored on the memory 236. The memory 236 at least stores program instructions configured to implement a charging protocol 236 and any data required therefor, such as current-voltage profiles, current-temperature profiles, and/or equivalent look-up tables. The memory 236 may be of any type of device capable of storing information accessible by the BMS 110, such as a memory card, ROM, RAM, write-capable memories, read-only memories, hard drives, discs, flash memory, or any of various other computer-readable media serving as data storage devices as will be recognized by those of ordinary skill in the art. Additionally, it will be recognized by those of ordinary skill in the art that a “processor” includes any hardware system, hardware mechanism or hardware component that processes data, signals, or other information. Thus, the BMS 110 may include a system with a central processing unit, multiple processing units, dedicated circuitry for achieving specific functionality, or other systems.

The BMS 110 further comprises at least one network communications module 234 that provides an interface for communication with any of various other devices, at least including the cloud backend 120. The network communications module 234 may comprise one or more transceivers, modems, processors, memories, oscillators, antennas, or other hardware conventionally included in a communications module to enable communications with various other devices. Particularly, the network communications module 336 generally includes one or more cellular modems configured to communicate with wireless telephony networks, but may further include a Bluetooth® module (not shown) and/or a Wi-Fi module configured to enable communication with a Wi-Fi network and/or Wi-Fi router (not shown). Communications may be accomplished using any of various known communications protocols.

The system 200 further includes a current sensor 218, voltage sensor 220, and a temperature sensor 222 configured to monitor battery current, battery voltage, and battery temperature, respectively, at least during the charging/discharging process. The BMS 110 is operably connected to the current sensor 218, to the voltage sensor 220, and to the temperature sensor 222, and configured to receive measurement signals corresponding to the battery current, the battery voltage, and the battery temperature. In one embodiment, the current sensor 218 includes a shunt resistor arranged in series with the battery 104 which provides a voltage that is proportional to the battery current. In one embodiment, the current sensor 218 comprises a Hall Effect sensor arranged in series with the battery 104 and configured to measure the battery current. The voltage sensor 220 is connected in parallel with the battery 104 and is configured to measure a battery voltage across the positive and negative battery terminals 206, 208 of the battery 104. In some embodiments, the voltage sensor is further configured to measure voltages of individual cells 204 of the battery 104. In some embodiments, the processor 230 is configured to determine, calculate, and/or estimate further battery parameters such as state of charge, state of health, impedance, capacity, open-circuit voltage, and/or rest voltage.

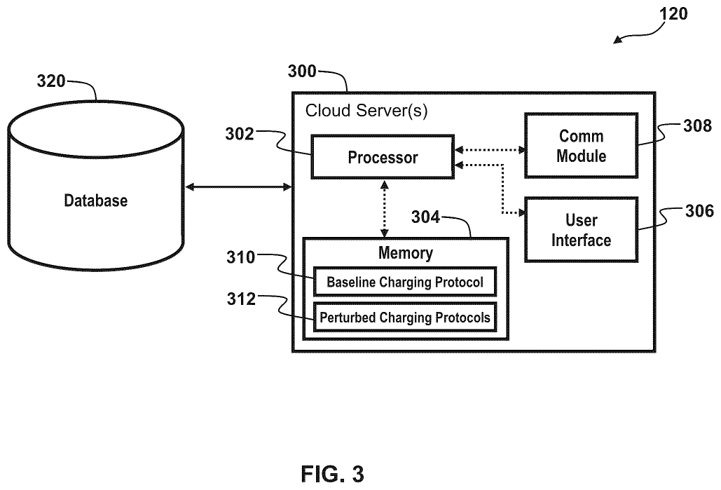

FIG. 3 shows exemplary components of the cloud backend 120. The cloud backend 120 comprises one or more cloud servers 300 and one or more databases 320. The cloud servers 300 may include servers configured to serve a variety of functions for the cloud backend 120, but at least include one or more servers configured to manage battery data received from the BMS 110 of the fleet of electric vehicles, and to optimize the charging protocol(s) utilized by the fleet of electric vehicles 102 for charging their batteries 104. Each of the cloud servers 300 includes, for example, a processor 302, a memory 304, a user interface 306, and a network communications module 308. It will be appreciated that the illustrated embodiment of the cloud servers 300 is only one exemplary embodiment of a cloud server 300 and is merely representative of any of various manners or configurations of a personal computer, server, or any other data processing systems that are operative in the manner set forth herein.

The processor 302 is configured to execute instructions to operate the cloud servers 300 to enable the features, functionality, characteristics and/or the like as described herein. To this end, the processor 302 is operably connected to the memory 304, the user interface 306, and the network communications module 308. The processor 302 generally comprises one or more processors which may operate in parallel or otherwise in concert with one another. It will be recognized by those of ordinary skill in the art that a “processor” includes any hardware system, hardware mechanism or hardware component that processes data, signals or other information. Thus, the processor 302 may include a system with a central processing unit, graphics processing units, multiple processing units, dedicated circuitry for achieving functionality, programmable logic, or other processing systems.

The databases 320 are configured to store battery data received from the BMS 110. The databases 320 may be of any type of long-term non-volatile storage device capable of storing information accessible by the processor 302, such as hard drives or any of various other computer-readable storage media recognized by those of ordinary skill in the art. Likewise, the memory 304 is configured to store program instructions that, when executed by the processor 302, enable the cloud servers 300 to perform various operations described herein, including optimizing the charging protocol(s) utilized by the fleet of electric vehicles 102 for charging their batteries. Additionally, as will be discussed in greater detail below, the memory 304 stores a baseline charging protocol 310 and one or more perturbed charging protocols 312. The memory 304 may be of any type of device or combination of devices capable of storing information accessible by the processor 302, such as memory cards, ROM, RAM, hard drives, discs, flash memory, or any of various other computer-readable media recognized by those of ordinary skill in the art.

The network communications module 308 of the cloud servers 300 provides an interface that allows for communication with any of various devices, at least including the BMS 110. In particular, the network communications module 308 may include a local area network port that allows for communication with any of various local computers housed in the same or nearby facility. Generally, the cloud servers 300 communicate with remote computers over the Internet via a separate modem and/or router of the local area network. Alternatively, the network communications module 308 may further include a wide area network port that allows for communications over the Internet. In one embodiment, the network communications module 308 is equipped with a Wi-Fi transceiver or other wireless communications device. Accordingly, it will be appreciated that communications with the cloud servers 300 may occur via wired communications or via the wireless communications. Communications may be accomplished using any of various known communications protocols.

The cloud servers 300 may be operated locally or remotely by an administrator. To facilitate local operation, the cloud servers 300 may include a user interface 306. In at least one embodiment, the user interface 306 may suitably include an LCD display screen or the like, a mouse or other pointing device, a keyboard or other keypad, speakers, and a microphone, as will be recognized by those of ordinary skill in the art. Alternatively, in some embodiments, an administrator may operate the cloud servers 300 remotely from another computing device which is in communication therewith via the network communications module 308 and has an analogous user interface.

The cloud backend 120 is configured to store and manage the battery data on the databases 320 in a secure way and provide access to the battery data for the purpose of optimizing the charging protocol(s) utilized by the fleet of electric vehicles 102 for charging their batteries. The memory 304 stores program instructions for optimizing battery charging protocols across a fleet of electric vehicles.

### Methods for Optimizing Battery Charging Protocols Across a Fleet of Electric Vehicles

A variety of methods and processes are described below for operating the BMS 110 and the cloud backend 120. In these descriptions, statements that a method, processor, and/or system is performing some task or function refers to a controller or processor (e.g., the processor 230 of the BMS 110 or the processor 302 of the cloud backend 120) executing programmed instructions stored in non-transitory computer readable storage media (e.g., the memory 232 of the BMS 110 or the memory 304 of the cloud storage backend 120) operatively connected to the controller or processor to manipulate data or to operate one or more components in the system 100 to perform the task or function. Additionally, the steps of the methods may be performed in any feasible chronological order, regardless of the order shown in the figures or the order in which the steps are described.

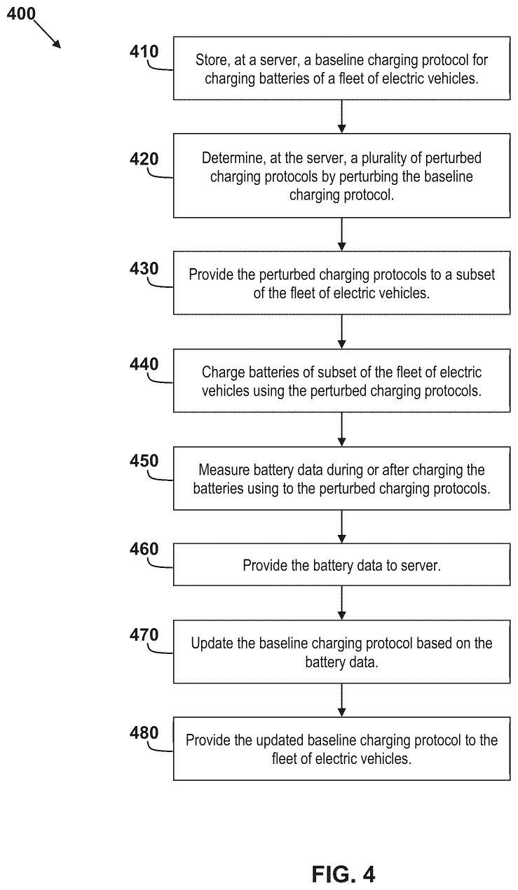

FIG. 4 shows a method 400 for optimizing battery charging protocols across a fleet of electric vehicles. The method advantageously adapts and improves the charging protocol(s) deployed on the fleet of electric vehicles 102 over time based on real-world data from the fleet.

The method 400 begins with storing, at a server, a baseline charging protocol for charging batteries of a fleet of electric vehicles (block 410). Particularly, the cloud backend 120 stores, in the memory 304, the baseline charging protocol 310. This baseline charging protocol 310 is also deployed to the BMS 110 of each electric vehicle 102 in the fleet. As discussed above, the baseline charging protocol 310 may, for example, be originally designed by a battery manufacturer prior to release of the electric vehicle 102 and originally deployed on the BMS 110 at the time of manufacture. Alternatively, the baseline charging protocol 310 may be designed based on lab tests or battery models, and subsequently deployed in the BMS 110 of each electric vehicle 102 by transmitting the baseline charging protocol 310 to the BMS 110 of each electric vehicle 102 using the network communications module 308.

In at least some embodiments, the baseline charging protocol 310 includes controlling a charging current as a function of battery voltage and battery temperature or as a function of battery state-of-charge and battery temperature, as expressed by one or more charging profiles. Particularly, the baseline charging protocol 310 may include charging the battery 102 according to a baseline current-voltage profile. Additionally, the baseline charging protocol 310 may further include charging the battery 102 according to a baseline current-temperature profile. Finally, the baseline charging protocol 310 may further include charging the battery 102 according to a baseline current-SOC profile. In at least one embodiment, the baseline charging protocol 310 is characterized by a plurality of baseline current-voltage profiles corresponding to a plurality different battery temperatures. In another embodiment, the baseline charging protocol 310 is characterized by a plurality of baseline current-SOC profiles corresponding to a plurality different battery temperatures. For a given battery temperature, the baseline charging protocol 310 charges the battery 102 according to a baseline current-temperature profile associated with the given battery temperature. In some embodiments, each charging profile is embodied by a look-up table that provides a charging current given a particular battery voltage and/or battery temperature. Alternatively, in other embodiments, each charging profile is embodied as a mathematical function and/or equation.

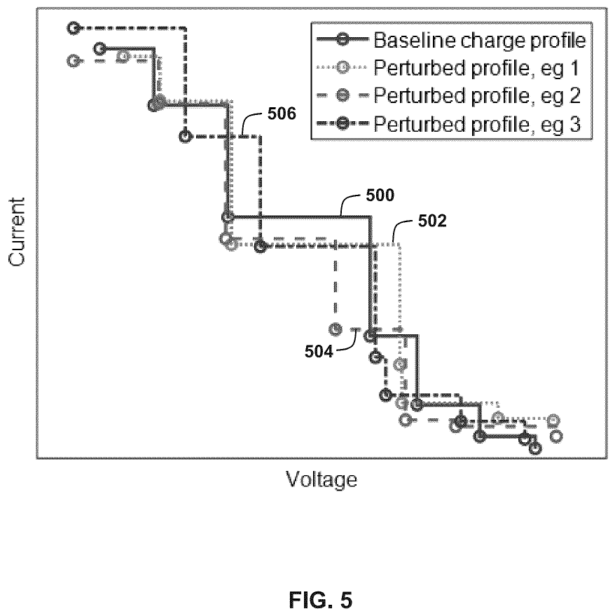

FIG. 5 shows an exemplary baseline current-voltage profile 500 for a particular battery temperature. As can be seen, the baseline current-voltage profile 500 has a stair step-like shape comprising segments in which different ranges of battery voltages correspond to different constant charging currents. As can be seen, relatively higher charging currents are applied in response to relatively lower battery voltages, and relatively lower charging currents are applied in response to relatively higher battery voltages, resulting an overall negative slope to the baseline current-voltage profile 500. However, it should be appreciated that the charging current profiles may be non-monotonic (e.g., starting at lower currents, then increasing, before decreasing again). Moreover, it should be appreciated that, although the exemplary baseline current-voltage profile 500 has stair step-like shape (which will generally make for easier implementation by the BMS 110 and/or charge controller 214), the baseline current-voltage profile can have a wide variety of shapes and patterns. As noted above, a plurality of such baseline current-voltage profiles may be provided for a plurality of different battery temperatures.

Returning to FIG. 4, the method 400 continues with determining, at the server, a plurality of perturbed charging protocols by perturbing the baseline charging protocol (block 420). Particularly, the processor 302 of the cloud backend 120 determines a plurality of perturbed charging protocols 312 by modifying the baseline charging protocol 310. The perturbed charging protocols 312 may also be referred to herein as alternative charging protocols, modified charging protocols, or experimental charging protocols. The processor 302 determines a plurality of perturbed charging protocols 312 by modifying at least one baseline current-voltage profile (and/or at least one baseline current-temperature profile) of the baseline charging protocol 310.

Each perturbed charging protocols 312 includes one or both of a perturbed current-voltage profile and a perturbed current-temperature profile, which incorporate small deviations from those of the baseline charging protocol, while maintaining a substantially similar charge time, so that there is no discernible impact on driver experience. In particular, in at least some embodiments, each perturbed charging protocol 312 is characterized by a plurality of perturbed current-voltage profiles corresponding to a plurality of different battery temperatures. These perturbed charging protocols 312, in particular the perturbed current-voltage profiles and/or current-temperature profiles can be derived in a variety of manners.

In at least one embodiment, the processor 302 of the cloud backend 120 determines a plurality of perturbed charging protocols 312 by applying a battery model to find alternative current-voltage profiles and/or current-temperature profiles that are expected to result in charging time that is within a predetermined threshold difference from a charging time that results from the baseline current-voltage profile. The predetermined threshold difference in the resulting charging time may be defined as being within +/−15% of a baseline charging time of the baseline charging protocol 310, more particularly, within +/−10% of the baseline charging time of the baseline charging protocol 310, or even more particularly, within +/−5% of the baseline charging time of the baseline charging protocol 310. In some embodiments, the processor 302 modifies parameters of the battery model, such as internal state limits for the battery, to derive the plurality of perturbed charging protocols 312.

In another embodiment, the processor 302 of the cloud backend 120 determines a plurality of perturbed charging protocols 312 by discretizing the baseline current-voltage profiles and/or current-temperature profiles and modify values of the baseline current-voltage profiles and/or current-temperature profiles, either randomly or procedurally according to some ruleset that ensures that the modified current-voltage profiles and/or current-temperature profiles are expected to result in a similar charging time when used to charge the battery 104.

With reference again to FIG. 5, exemplary perturbed current-voltage profiles 502, 504, and 506 of exemplary perturbed charging protocols for a particular battery temperature are shown. Much like the baseline current-voltage profile 500, the exemplary current-voltage profiles 502, 504, and 506 are stair step-like shape comprising segments in which a range of battery voltages correspond to a constant current but with small changes to both the voltage thresholds as well as the charge current to be applied during a particular step. It should be appreciated, however, that the perturbed current-voltage profiles 502, 504, and 506 can have a wide variety of other shapes and patterns. Moreover, as noted above, a plurality of such perturbed current-voltage profiles may be provided for a plurality of different battery temperatures.

Returning to FIG. 4, the method 400 continues with providing the perturbed charging protocols to a subset of the fleet of electric vehicles (block 430). Particularly, the processor 302 of the cloud backend 120 selects a subset of electric vehicles 102 from the fleet of electric vehicles 102. Next, the processor 302 operates the network communications module 308 to transmit, to each electric vehicle 102 in the subset of electric vehicles 102, a respective one of the perturbed charging protocols 312. At each respective electric vehicle 102 in the subset of electric vehicles 102, the BMS 110 thereof receives the respective one of perturbed charging protocols 312 from the cloud backend 120 via the network communications module 234 thereof, and stores it in the memory 232 (i.e., as the charging protocol 236).

In some embodiments, the processor 302 selects the subset of electric vehicles 102 as a random subset of the fleet of electric vehicles 102. Alternatively, in some further embodiments, the processor 302 selects the subset of electric vehicles 102 depending on one or more of observed environmental conditions of the electric vehicles 102, observed driving styles of the electric vehicles 102, and/or observed charging behaviors of the electric vehicles 102. To these ends, in some embodiments, the processor 230 of the BMS 110 of each electric vehicle 102 is configured to continuously monitor and record data relating to environmental conditions, driving styles, and/or charging behaviors. The processor 230 operates the network communications module 234 thereof to transmit this data to the cloud backend 120, which receives it via the network communications module 308. The processor 302 of the cloud backend 120 may selects the subset of electric vehicles 102 depending on this data relating to environmental conditions, driving styles, and/or charging behaviors.

In general, the subset of the fleet of electric vehicles 102 is a small portion of the entire fleet of electric vehicles 102, e.g., 5-10% of the overall size of the fleet. The subset of electric vehicle 102 should be large enough to provide a representative sample of the environmental conditions, driving styles, and/or charging behaviors of the fleet as a whole.

The method 400 continues with charging batteries of subset of the fleet of electric vehicles using the perturbed charging protocols (block 440). Particularly, after the perturbed charging protocols 312 are provided to the subset of the fleet of electric vehicles 102, the BMS 10 of each vehicle 102 in the subset is configured to charge the battery 104 using the respectively received one of the perturbed charging protocols 312. The BMS 10 commands the charge controller 214 to operate the power electronics 216 in such a manner as to control the charging current in accordance with the respectively received one of the perturbed charging protocols 312.

During the charging process, the BMS 10 and/or the charge controller 214 sets the charging current dependent on a current battery temperature and a current battery voltage, in accordance with the perturbed current-voltage profile(s) and/or perturbed current-temperature profile(s) of the respectively received one of the perturbed charging protocols 312. In at least one embodiment, the perturbed charging protocol 312 defines a plurality of current-voltage profiles, each associated with a different respective battery temperature. The BMS 10 and/or the charge controller 214 selects a respective one of current-voltage profiles depending on the current battery temperature, and then sets the charging current based on the selected current-voltage profiles depending on the current battery voltage.

The batteries 104 of the subset of the fleet of electric vehicles 102 are charged using the perturbed charging protocols 312 for a predetermined period of time, e.g., for a predetermined number of weeks or months. During this predetermined period of time, there is no adverse impact on driver experience for the subset of the fleet of electric vehicles 102 because the perturbations to the baseline charging protocol 310 are small and result in similar charging times.

The method 400 continues with measuring battery data during or after charging the batteries using to the perturbed charging protocols (block 450). During the predetermined period of time, in addition to causing the battery 104 to be charged using the respectively received one of the perturbed charging protocols 312, the BMS 10 operates the sensors 218, 220, 222 to collect a plurality of battery data for the purpose of observing the impact of the perturbed charging protocols 312 on the battery aging. As used herein “battery data” refers to any sensor data that is relevant to the performance, health, and/or aging of the battery. These battery data may, for example, include battery currents, battery voltages, and battery temperatures measured over time during or after charging of the battery 104 using one of the perturbed charging protocols 312. These battery data may be collected for the battery 104 as a whole or for individual cells of the battery 104. In some embodiments, the BMS 10 will derive further battery data one the basis of directly measured sensor data from the sensors 218, 220, 222, such as states of charge or other metrics of the battery 104. This data can then be used to estimate the battery state of health during operation, and track how this state of health changes over the monitoring period of a few weeks or months.

Based on tracking the state of health for this subset of the fleet over a period of time, the local gradient of an objective/cost function (battery aging rate) relative to the charging protocol can be calculated, and potential directions in which the current-voltage and/or current-temperature profiles thereof should be updated to improve the optimality of the objective function can be derived.

The method 400 continues with providing the battery data to server (block 460). At each respective electric vehicle 102 in the subset of electric vehicles 102, the processor 230 of the respective BMS 110 operates the network communications module 234 thereof to transmit the battery data collected during the predetermined period of time to the cloud backend 120. The cloud backend 120 receives respective battery data from each vehicle in the subset of electric vehicles 102 and stores the battery data in database 320.

The method 400 continues with updating the baseline charging protocol based on the battery data (block 470). Particularly, the processor 302 of the cloud backend 120 updates the baseline charging protocol 310 based on the battery data received from subset of electric vehicles 102 and based on the associated perturbed charging protocols 312. In some embodiments, the processor 203 determines a modification to the baseline charging protocol 310 that will result in at least one of (i) a slower battery aging and (ii) a faster charging time, compared to the baseline charging protocol 310. In at least one embodiment, the processor 302 updates the baseline charging protocol 310 using a predetermined objective/cost function that optimizes charging time and battery aging.

In at least one embodiment, the processor 302 identifies a perturbed charging protocol from the plurality of perturbed charging protocols 312 that resulted in at least one of (i) a slower battery aging and (ii) a faster charging time, compared to the baseline charging protocol. Next, the processor 302 determines the modification to the baseline charging protocol 310 based on the identified one of the perturbed charging protocols 312.

In at least one embodiment, the processor 302 of the cloud backend 120 determines updated internal state limits for the batteries 104 based on the received battery data and/or based on the identified one of the perturbed charging protocols 312. Next, the processor 302 updates the baseline charging protocol 310 by applying a battery model using the updated internal state limits.

In another embodiment, the processor 302 of the cloud backend 120 determines one or more gradients based on the battery data received in association with each perturbed charging protocol 312. Next, the processor 302 updates the baseline charging protocol 310 based on the gradient(s) using a gradient-based updating method.

The method 400 continues with providing the updated baseline charging protocol to the fleet of electric vehicles (block 480). Particularly, the processor 302 of the cloud backend 120 operates the network communications module 308 thereof to transmit the updated baseline charging protocol to all, or at least some, of the electric vehicles 102 in the fleet of electric vehicles 10. At each electric vehicle 102, the BMS 110 receives the updated baseline charging protocol from the cloud backend 120 via the network communications module 234 thereof, and stores it in the memory 232 (i.e., as the charging protocol 236).

Once provided with the updated baseline charging protocol, the BMS 10 charges the battery 104 using the updated baseline charging protocol, thereby advantageously providing improved performance and/or reduced aging of the battery 104.

The above process could be iterated periodically to further update the baseline charging protocol. Particularly, in each iteration of the method, a new subset of electric vehicles 102 is selected from the fleet of electric vehicles 102 and a new plurality of perturbed charging protocols is generated. In this way, the charge protocols can be continuously adapted and improved upon for the entire lifetime of the vehicles 102 in the fleet. Further, new vehicles deployed on the road could be directly provided with the updated baseline charge protocol rather than the original baseline protocol, thereby providing an immediate benefit to those drivers.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for adapting a charging protocol for charging batteries of a plurality of electric vehicles, the method comprising:
storing, in a memory of a server, a baseline charging protocol;
determining, with a processor of the server, a plurality of alternative charging protocols by modifying the baseline charging protocol;
transmitting, with a transceiver of the server, to each respective electric vehicle from a subset of the plurality of electric vehicles, a respective alternative charging protocol from the plurality of alternative charging protocols, the subset of the plurality of electric vehicles being configured to charge batteries thereof according to the plurality of alternative charging protocols;
receiving, with the transceiver, battery data from the subset of the plurality of electric vehicles, the battery data having been measured during or after charging the batteries of the subset of the plurality of electric vehicles according to the plurality of alternative charging protocols; and
updating, with the processor, the baseline charging protocol based on the battery data.

2. The method according to claim 1, wherein the baseline charging protocol and the plurality of alternative charging protocols include charging according to a respective current-voltage profile that sets a charging current depending on a battery voltage.

3. The method according to claim 2, wherein the baseline charging protocol and the plurality of alternative charging protocols include selecting the respective current-voltage profile from a plurality of baseline current-voltage profiles depending on a current battery temperature, each of plurality of baseline current-voltage profiles being associated with a different respective battery temperature.

4. The method according to claim 2, the determining the plurality of alternative charging protocols further comprising:
modifying the current-voltage profile of the baseline charging protocol.

5. The method according to claim 4, the modifying the current-voltage profile further comprising:
applying a battery model to determine a modified current-voltage profile that will result in charging time that is within a predetermined threshold difference from a charging time that results from the current-voltage profile of the baseline charging protocol.

6. The method according to claim 5, the applying the battery model further comprising:
modifying at least one internal state limit in the battery model.

7. The method according to claim 1, wherein:
the subset of the plurality of electric vehicles are configured to charge the batteries thereof according to the plurality of alternative charging protocols for a predetermined period of time; and
the battery data is measured during or after predetermined period of time.

8. The method according to claim 7, wherein the predetermined period of time is at least one week.

9. The method according to claim 1, wherein the battery data includes at least one of (i) battery current measurements, (ii) battery voltage measurements, (iii) battery temperature measurements, and (iv) battery state of charge measurements.

10. The method according to claim 1, the updating the baseline charging protocol further comprising:
determining, based on the battery data, a modification to the baseline charging protocol that will result in at least one of (i) a slower battery aging and (ii) a faster charging time, compared to the baseline charging protocol; and
updating the baseline charging protocol according the determined modification.

11. The method according to claim 10, the determining the modification to the baseline charging protocol further comprising:
identifying, based on the battery data, an alternative charging protocol from the plurality of alternative charging protocols that resulted in at least one of (i) a slower battery aging and (ii) a faster charging time, compared to the baseline charging protocol; and
determining the modification to the baseline charging protocol based on the identified alternative charging protocol.

12. The method according to claim 1, the updating the baseline charging protocol further comprising:
determining, based on the battery data, updated internal state limits for a battery model; and
updating the baseline charging protocol by applying the battery model with the updated internal state limits.

13. The method according to claim 1, the updating the baseline charging protocol further comprising:
determining a gradient based on the battery data; and
updating the baseline charging protocol based on the gradient.

14. The method according to claim 1 further comprising:
transmitting, with the transceiver, the updated baseline charging protocol to the plurality of electric vehicles, the plurality of electric vehicles being configured to charge the batteries thereof according to the updated baseline charging protocol.

15. The method according to claim 1 further comprising:
selecting, with the processor, the subset of the plurality of electric vehicles from the plurality of electric vehicles.

16. The method according to claim 15, the selecting the subset of the plurality of electric vehicles further comprising:
selecting the subset of the plurality of electric vehicles as a random subset of the plurality of electric vehicles.

17. The method according to claim 15, the selecting the subset of the plurality of electric vehicles further comprising:
selecting the subset of the plurality of electric vehicles depending on at least one of (i) environmental conditions, (ii) driving styles, and (iii) charging behaviors associated with the plurality of electric vehicles.

18. The method according to claim 17, wherein the plurality of electric vehicles are configured to measure data including at least one of (i) environmental condition data, (ii) driving style data, and (iii) charging behavior data, the method further comprising:
receiving, with the transceiver, the data from the plurality of electric vehicles.

19. The method according to claim 15, wherein the method is iterated periodically to further update the baseline charging protocol, each iteration of the method including selecting a new subset of the plurality of electric vehicles from the plurality of electric vehicles and determining a new plurality of alternative charging protocols.

20. A method for adapting a charging protocol for charging a battery of an electric vehicle, the method comprising:
receiving, with a transceiver of a battery management system, an alternative charging protocol from a server;
controlling, with a processor of the battery management system, a charging of the battery according to the alternative charging protocol;
measuring, with at least one sensor of the battery management system, battery data during or after the charging of the battery according to the alternative charging protocol;
transmitting, with the transceiver, the battery data to the server; and
receiving, with the transceiver, an updated baseline charging protocol, the updated baseline charging protocol having been determined based on the battery data and further battery data from further electric vehicles.
